(19) United States
(12) Patent Application Publication
(10) Pub. No.: US 2004/0192398 A1
(43) Pub. Date: Sep. 30, 2004

(54) Kind of mobile telephone having rotation display screen

(76) Inventor: Zhanxin Zhu, Beijing (CN)

Correspondence Address: LADAS & PARRY, 26 WEST 61ST STREET, NEW YORK, NY, 10023, US

(21) Appl. No.: 10/484,396

(22) PCT Filed: Jul. 9, 2002
(86) PCT No.: PCT/CN02/00487

(30) Foreign Application Priority Data
Jul. 19, 2001 (CN) 01231830.2
Aug. 8, 2001 (CN) 01124035.0

(51) Int. Cl. H04M 1/00

(52) U.S. Cl. 455/566; 455/550.1

(57) ABSTRACT

The present invention discloses a mobile telephone having a rotatable display screen, the mobile telephone comprising a main body (11) and a display screen (12), wherein the display screen (12) is coupled to the main body (11) via coupling means, and the projection plane of the display screen can rotate in parallel relative to the main body when the coupling means is served as an axes for rotation. The mobile telephone having a rotatable display screen of the present invention, makes the width formed between the thumb and the other fingers folding towards the palm of the hand for holding an object the most comfortable width, and can satisfy the users' holding habits. And rotating the display screen enables the horizontal size of the display screen larger than the vertical size, whereby satisfying the users' viewing habits.

### FIELD OF THE INVENTION

The present invention relates to mobile communication field, and more specifically, to a mobile telephone having a rotatable display screen.

### BACKGROUND OF THE INVENTION

Nowadays, the display screen of a mobile communicating equipment is fixed together with its main body (i.e., all of the other parts except the display screen). So is for the mobile telephone, the display screen of which cannot rotate in parallel relative to the main body.

With continuously increasing of the amount of information and the improvement of the entertainment functionality, users wish the size of display screen of mobile telephone be as large as possible. In general, the most comfortable width for an object to be held in the palm of a person is 4.5 cm to 6.5 cm. If the width of an object is larger than this size, the person feels bad when holding the object, and feels tired when holding the object for a long time. This makes that mobile telephone's display screen could be expanded only along the upright “1” for increasing its size. Though the result of increasing the size of the display screen satisfies the requirement of transferring and displaying information for the user, while the user is viewing network movies and literature programs through mobile telephone, the user cannot see the whole view as they used to, because the horizontal size is less than vertical size, thereby the user cannot obtain the enjoyment of vision.

In today's market, there appears a mobile telephone displayed in the manner of horizontal “1” font. When the display screen of the mobile telephone is viewed, it can adapt to the user's viewing habit for the larger size in horizontal than in vertical, moderate proportion between the length and the width and good visibility. However, using this kind of mobile telephone need to hold it transversely in hand or nip it in hand, this is beyond the most comfortable width for holding an object in a hand. And, as an angle between the hand holding the object and the arm is formed, one would feel both comfortless and tired when using the mobile telephone. Further, the operation is not convenient and the safety is not good.

### SUMMARY OF THE INVENTION

The present invention provides a mobile telephone having a rotatable display screen to overcome the problems existing in the prior art. The invention can rotate the display screen of the mobile telephone, for both satisfying the requirement in viewing for user, and making the user hold the mobile telephone with the most comfortable width and angle.

The present invention provides a mobile telephone having a rotatable display screen, the mobile telephone comprising a main body and a display screen, wherein the display screen is coupled to the main body via a coupling means, and the projection plane of the display screen can rotate in parallel relative to the main body with the coupling means serving as the axes of the rotation of the display screen.

In the present invention, on the back of the display screen there is an extrusive cylinder 20 with a groove 22 in its lengthways. On the upper portion of the main body of the mobile telephone, there is a concave circular hole 23 on which there is a vertical flute 24 for holding a fixed card. The above-described coupling means is formed by inserting the cylinder 20 of the display screen into the concave circular hole 23.

The mobile telephone having a rotatable display screen according to the present invention, makes the width formed between the thumb and the other fingers folding towards the palm of the hand for holding an object the most comfortable width, and can satisfy the users' holding habits. And rotating the display screen enables the horizontal size of the display screen larger than the vertical size, whereby satisfying the users' viewing habits. Using the functional touch button in the form of computer keypad on the main body of the mobile telephone in combination with the communication operation functional key-press, can not only adapts to the users' dialing habits, but also increase the speed of the networking operation.

### BRIEF DESCRIPTION OF THE DRAWINGS

In conjunction with embodiments, the mobile telephone having a ratatable display screen according to the present invention is described with reference to the accompanying drawing, wherein:

FIG. 1 shows a front view of a mobile telephone having a rotatable display screen according to the present invention;

FIG. 2 shows a schematic view of for the case of an angle of 90 degree between the rotatable display screen and the main body of a mobile telephone according to the present invention;

FIG. 3 shows a structure of the rear portion of a display screen;

FIG. 4 shows a side view of the display screen; and

FIG. 5 shows a side view of the main body.

### DETAILED DESCRIPTION OF THE EMBODIMENTS OF THE INVENTION

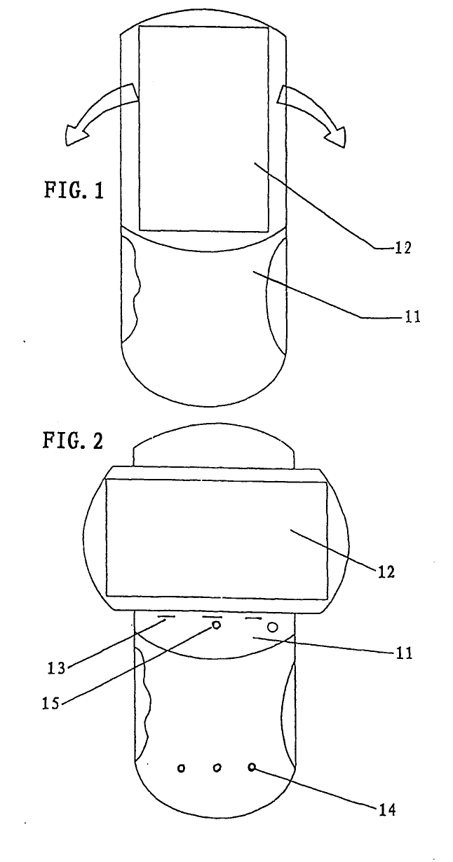

A mobile telephone having a rotatable display screen according to the present invention is shown in FIG. 1. The mobile telephone consists of a display screen 12 and a main body 11. The invention differs from the prior art in that, instead of being fixed on the main body 11, the display screen 12 is coupled to the main body 11, and can rotate in parallel relative to the main body via its coupling means, as shown in FIG. 2. The relative size of the horizontal and vertical sizes of the display screen will interchange with the rotating of the display screen, since the display screen can be placed upright or transversely relative to the main body 11.

Generally, the mobile telephone according to the present invention is used in the same way as one existing normal mobile telephone. After the plane of the display screen is rotated by an angle of 90 degrees in parallel relative to the main body 11, the display screen changes from a vertical screen to a horizontal screen whose horizontal size is larger than he vertical size, thereby adapting to the users' viewing habits when they are viewing network movies and literature programs. Also, the main body of the mobile telephone can be used as a platform on which the display screen can be replaced with various display screens of different specifications according to different usage requirements, so as to adapt to different viewing requirements. As the use of the mobile telephone according to the present invention does not change the best manner of holding a mobile telephones, which adapts to human body engineering principles, the functions can be operated easily and expediently.

Now with reference to FIG. 3 to FIG. 5, we will explain how does the display screen of the mobile telephone rotate in parallel relative to the main body.

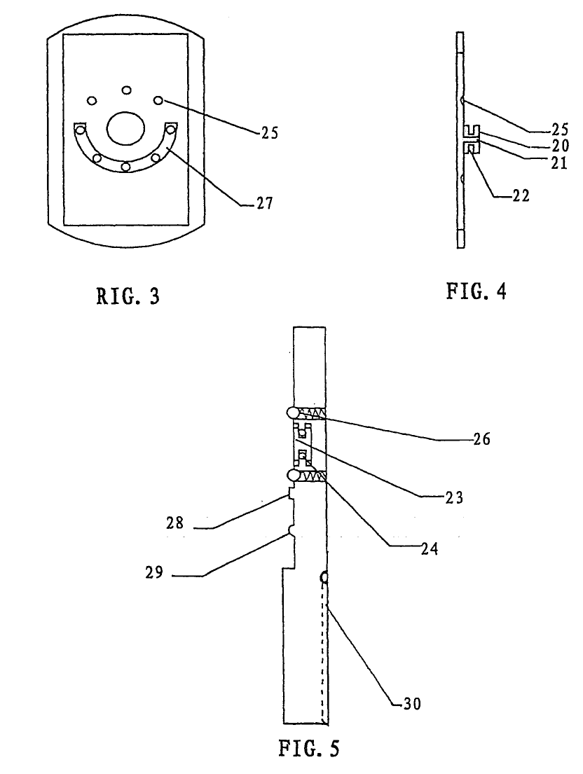

With reference to FIG. 4, there is an extrusive cylinder 20 on the back of display screen 12, and there is hole 21 in the transverse portion of the extrusive cylinder 20. The display screen is connected to each of the systems of the main body via hole 21. In the lengthways of the cylinder 20, there is groove 22 which is used for coupling the display screen and the main body.

With reference to FIG. 5, on the upper portion of the main body of the mobile telephone, there is a concave circular hole 23 on which there is a vertical flute 24 for holding a fixed card. When cylinder 20 of the display screen is inserted into the concave circular hole 23 on the main body of the mobile telephone, groove 22 of cylinder 20 is inserted into and in parallel with the vertical flute of the main body, and is fixed by fixed card 24. So that, the display screen is coupled to the main body of the mobile telephone, and can only rotate but not move relative to the main body. If a larger display screen is to be replaced with for better viewing effect, the only thing need to do is hurdling the spring of the fixed card, pulling the display screen out of the main body of the mobile telephone, and then replacing it.

In order that the display screen can rotate and can be fixed at a certain angle, there are concave holes 25 with the same spacing between each other around a circle on the back of the display screen. Several half-protuberant spring balls 26 are mounted on the upper portion of the main body of the mobile telephone. When rotating the display screen, if the concave holes 25 on the back of the display screen match with the half-protuberant spring balls 26 on the main body, then the display screen is locked.

At this time, the figure formed by the plane of the display screen, and the plane of the main body of the mobile telephone looks like letter “T” or half of the letter T (“r”) for containing the angle of 90 degree. Whether letter “T” or half of the letter T (“r”) is presented depends mainly on the specific position of the cylinder 20 on the back of the display screen. In the case of cylinder 20 locating in the central portion of the back of the display screen, after rotating the display screen by 90 degrees, the figure presented by the display screen and the main body looks like letter “T”. In the case of cylinder 20 locating on the top of the central line of the back of the display screen, after rotating the display screen by 90 degrees, the figure presented by the display screen and the main body looks like half of letter T (“r”). If a complete letter “T” is needed, it is required that the display screen be further moved upwards. In this case, a vertical groove is needed on the main body for matching the upward movement of the display screen.

Both of the structures of letter “T” half of letter T (“r”) adapts not only to normal standing type mobile telephones, but also to turning-over type mobile telephones (sometimes referred to as fold-up mobile telephones). The display screen of a turning-over type mobile telephone faces to the operation parts of the main body. The shape like letter “T” or half of letter T (“r”) is formed by the display screen and the main body after rotating the display screen around the axes serving as the connection between the connection between the display screen and the main body. One of the projection planes of the display screen can be formed only by rotating the display screen in parallel with and relative to the main body.

The present invention is further improved for preventing the display screen from rotating leftwards or rightwards excessively by more than 90 degrees. To this end, a groove 27 in the shape of a half-circular arc on the back of the display screen is arranged for matching with the restricting block 28 on the main body and restricting the display screen from rotating leftwards or rightwards excessively by more than 90 degrees. The operational principle of this arrangement is that, when the display screen is rotated by 90 degrees, the end point of groove 27 that is in the shape of a half-circular arc on the back of the display screen hits the restricting block on the main body of the mobile telephone, this will block the display screen from rotating any more, thereby limit the maximum angle of rotating the display screen.

The character turning control knob 29 on the upper portion of the main body of the mobile telephone is in a depressed state usually. When the display screen changes from a vertical position to a horizontal position after rotating by 90 degrees, the control knob 29 switches on the character turning system of the screen while ejecting from the depressed state automatically, making the original characters turning 90 degrees automatically, and arranging the text in a new format.

At the same time, the concealed functional touch button 13 in the form of computer keypad reveals. The advantage of this is that, the communicating operation functional buttons are made obvious for the users for facilitating them to make phone expediently with the buttons to their tastes. Functional touch button 13 hides on the back of the display screen. Such arrangement will not lead the size of the screen to be increased, and will reduce the area taken up by the operational functional button 14 in the front area of a mobile telephone as much as possible so that to increase the area of the display screen. When the touch button 13 in the form of computer keypad is clicked and touched, the arrangement also makes networking operation with a mobile phone easily and fastly. Operating revealed and concealed keys or buttons by combining the two types of keys or buttons can not only satisfy the requirement of operational function, but also make full use of the limited room on a mobile phone.

And, a concealed photographing head 15 facilitates both video conference hookup and video communication. A conjoint bracket 30 can support the mobile telephone at the desk in various angles for easy video viewing.

Further, fingerprint-information transmitting means is loaded into the mobile telephone, such that the operation in the field of finance, shopping, commerce, network, etc becomes safer.

Further, a green energy-saving powering system is loaded, which mixes with solar energy cell and the means of sensing the difference of temperature around the casing of the mobile telephone.

Further, compact, magnetic disk playback means are loaded into the mobile telephone, making full use of the space of the original solid battery. This not only improves the storage of the mobile telephone, but only enhances entertainment.

Further, burglarproof means makes the mobile telephone mooing for alarm once it leaves the owner for a certain distance, significantly reducing the possibility of the loss of the mobile telephone.

The mobile telephone having a rotatable display screen according to the invention is designed for the improvement of termination networking operation of the mobile communication and the video viewing in the future. It is convenient to carry for use, as the display screen being switched from upright to transverse in accordance with the requirement of viewing. And the main body of the mobile telephone can be used as technical platform, not only replacing the display screen with different sizes according to different requirements, but also having other detecting functions.

1. A mobile telephone having a rotatable display screen, comprising a main body and a display screen, wherein the display screen is coupled to the main body via coupling means, and the projection plane of the display screen can rotate in parallel relative to the main body with the coupling means serving as the axes of the rotation of the display screen.

2. The mobile telephone according to claim 1, wherein on the back of the display screen there is an extrusive cylinder (20), and in its lengthways there is a groove (22); on the upper portion of the main body of the mobile telephone there is a concave circular hole (23) on which there is a vertical flute (24) for holding a fixed card; said coupling means is formed by inserting the cylinder (20) of the display screen into the concave circular hole (23).

3. The mobile telephone according to claim 2, wherein there is a hole (21) in the transverse of the cylinder (20), the display screen being connected to each of the systems of the main body via the hole.

4. The mobile telephone according to claim 1, wherein the display screens of different sizes can replace the one on the main body.

5. The mobile telephone according to claim 2, there are concave holes (25) with the same spacing between each other around a circle on the back of the display screen; several half-protuberant spring balls (26) are mounted on the upper portion of the main body of the mobile telephone; when rotating the display screen, if the concave holes (25) on the back of the display screen match with the half-protuberant spring balls (26) on the main body, then the display screen is locked at a certain angle.

6. The mobile telephone according to claim 5, wherein there is a groove (27) in the shape of a half-circular arc on the back of the display screen is arranged for matching with the restricting block (28) on the main body and restricting the display screen from rotating leftwards or rightwards excessively by more than 90 degrees.

7. The mobile telephone according to claim 1, wherein there is a character turning control knob (29) on the main body.

8. The mobile telephone according to claim 1, wherein a functional touch button (13) in the form of computer keypad is provided on the main body, after rotating the display screen, the functional touch button (13) reveals.

9. The mobile telephone according to claim 1, wherein a concealed photographing head (15) is provided on the main body.

10. The mobile telephone according to claim 1, wherein there is a bracket (30) on the back of the main body.
